(19) United States
(12) Patent Application Publication
(10) Pub. No.: US 2011/0296513 A1
(43) Pub. Date: Dec. 1, 2011

(54) Location based security token

(76) Inventor: Farhad Kasad, Bothell, WA (US)

(21) Appl. No.: 13/067,354

(22) Filed: May 26, 2011

Related U.S. Application Data
(60) Provisional application No. 61/344,128, filed on May 27, 2010.

(51) Int. Cl. H04L 9/32; G06F 15/16; G06F 21/00

(52) U.S. Cl. 726/9

(57) ABSTRACT

A third, location-based level of security is added to physical possession, and entry of an authorized passcode, of an authentication token (or security token) fob to provide added security based on a location of attempted access to a secure network resource. A current location of the location-based authentication token fob is obtained, and combined with an entered passcode, to form a passcode key. The passcode key is compared against pre-registered authorized passcode keys (including pre-registered authorized locations for use of the location-based authentication token) to determine authorization for access.

This application claims priority from U.S. Provisional No. 61/344,128 entitled “Location Based Security Token”, filed May 27, 2010, the entirety of which is explicitly incorporated herein by reference.

### BACKGROUND OF THE INVENTION

1. Field of the Invention

This invention relates to secure mobile and wireless telecommunications.

2. Background of Related Art

An authentication token is a physical object, unlike a simple password. An authentication token, sometimes called a security token, is a device that a user physically carries to authorize access to a network service. Thus, the authentication token, or security token, is a security device given to an authorized user for them to keep in their possession. To log into a given secure network, the security token may be read directly like a credit card, or it may display a changing number that is typed in as a password. Some authentication tokens are a smart card, or a key fob.

An authentication token provides access security through an extra level of assurance using a two-factor authentication. In addition to the first security factor provided by physically having the device, a second security factor comprises the user's personal identification number (PIN), the combination of which authorizes that person for requested network services. Thus security is provided even if the physical device falls into the wrong hands because access can't be gained without knowledge of the user's PIN (which presumably only the user knows.) With the correct PIN, a conventional system then authorizes the user holding the device, typically by permitting them to log in.

Security tokens are available in multiple types. Some store cryptographic keys, digital signatures, biometrics and DNA as a means to determine that the possessing person is authorized. More advanced security tokens include Bluetooth™ capabilities, thereby converting them from being a static device to a device which communicates over voice communications or a short messaging system (SMS) to verify authentication of the user.

But the security tokens available today are reliant upon security algorithms and pass phrases. Security tokens are typically used in addition to or in place of a password to prove that the person signing in is who they claim to be. As such, conventional security token technologies depend on the use of stronger keys and enforcement of stronger passphrase constraints to enable a greater level of security.

### SUMMARY OF THE INVENTION

In accordance with the principles of the present invention, an authentication token having at least three levels of security comprises an authorization request module to trigger a wireless authorization request to a network being accessed, including a current location of an associated physical authentication token. A passcode entry module accepts entry of a passcode authorizing access to the network being accessed. Authorization of access to the network being accessed is contingent upon both the current location being in an authorized location for the physical authentication token, and the passcode being an authorized passcode.

A method of providing a third level of security to an authentication token fob in accordance with another aspect of the invention comprises obtaining a current location of an authentication token fob associated with an attempt to access a relevant secure network resource. The obtained current location is combined with a passcode entered by a current user associated with the authentication token fob to form a passcode key. The passcode key is compared to a database of authorized passcode keys associated with the authentication token fob, to determine authorization for access to the relevant secure network resource. Physical possession of the authentication token fob and entry of an authorized passcode are combined with a determination of an authorized location for use of the authentication token fob to provide three levels of security for access to the relevant secure network resource.

A method of providing a location-based level of security to an authentication token in accordance with yet another aspect comprises obtaining a current location of an authentication token associated with an attempt to access a relevant secure network resource. The current location of the authentication token is compared to a database of authorized locations for use of the authentication token, to determine authorization for access to the relevant secure network resource. Access to the relevant secure network resource is gained only when the authentication token is in an authorized region for authorized use.

### BRIEF DESCRIPTION OF THE DRAWINGS

Features and advantages of the present invention become apparent to those skilled in the art from the following description with reference to the drawings:

FIG. 1 shows an authentication token in possession of an authorized user in a pre-registered location(s) for access to a relevant wireless network, in accordance with the principles of the present invention.

FIG. 2 shows the refusal of the authentication token of FIG. 1, but in possession of an unauthorized user (e.g., a thief who stole the authentication token from the authorized user), who attempts to access the relevant wireless network from a location other than the pre-registered location(s), in accordance with the principles of the present invention.

FIG. 3 depicts details of an exemplary user authorized locations database, in accordance with the principles of the present invention.

### DETAILED DESCRIPTION OF ILLUSTRATIVE EMBODIMENTS

The present inventor has appreciated that even with stronger security algorithms and pass phrases, with the increased tools and techniques available to cyber criminals, a person with ill intent can nevertheless still gain unauthorized access to network systems that they are not themselves properly authorized to have access to if they are able to gain possession of the security key (e.g., through theft) and the authorized person's password.

The present invention provides a third level of security to otherwise conventional authentication tokens by combining, along with the need to (1) physically possess the authentication token; and (2) enter a proper passcode; (3) the need for a current location of the authentication/security token to be in a pre-authorized (e.g., registered) location or region. Fulfillment of all three aspects provide a stronger authentication technique than conventional authentication devices which require only physical possession of the authentication key, and entry of a correct passcode.

A location based authentication/security token requiring its physical possession in an authorized location in accordance with the principles of the present invention provides a significant, additional factor which enhances security tokens.

In one embodiment, if a coarse (or better) current location of the person accessing the system and possessing the authentication token is known, then the user is provisioned to be authenticated and thus allowed access to the accessed network resource, but only if the authentication token is at that coarse location when logging in.

In another embodiment, the current location of the authentication token is periodically or occasionally checked to be sure that the authentication token remains as the proper location. If not, access to the accessed network is preferably curtailed. In a higher secure environment, along with periodic checks of the current location of the authentication token, re-entry of the authorized passcode may also be periodically or occasionally required.

The present invention is described with respect to a device based location security token embodiment, as well as with respect to a network based location security token embodiment.

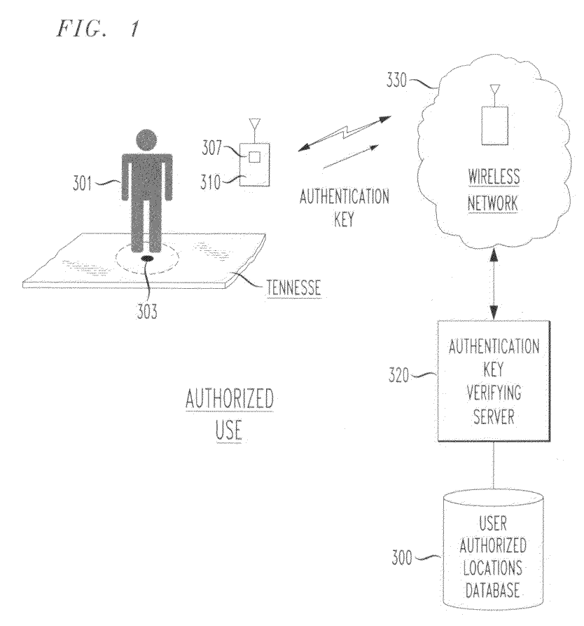

FIG. 1 shows an authentication token in possession of an authorized user in a pre-registered location(s) for access to a relevant wireless network, in accordance with the principles of the present invention.

In particular, as shown in FIG. 1, a location authentication token 310 is in the physical possession of an authorized user 301 at a pre-registered location 303 (e.g., the authorized user's home in the state of Tennessee) when they attempt to access a given resource within a wireless network 330.

A location authentication/security token 310 in accordance with the principles of the present invention utilizes an onboard Global Positioning System (GPS) chip 307 in the relevant security token device 310 to provide a third level of security over the two security factors otherwise provided by otherwise conventional security token devices.

In accordance with the embodiment of FIG. 1, a current location of the location authentication token 310 is automatically obtained (i.e., without user input) by an authentication key verifying server 320 in the wireless network 330 at a time of attempted network access. In the given embodiment the current location is provided by the location authentication token 310 itself, using its own satellite locating chip (e.g., Global Positioning System (GPS) or the like). The current location of the location authentication token 310 is then used, along with a suitable passphrase entered by the user 301 of the location authentication token 310, to construct a location-aided PIN key to determine authorization for the person in physical possession of the location authentication token 310 who is attempting to access the secure system.

The accessed secure system, e.g., the authentication key verifying server 320, then validates the user's PIN key-importantly in combination with the value of the automatically-determined current location of the location security token device, by comparison to the authorized key and pre-provisioned location value(s).

The authorized user 301 may pre-register one or more authorized locations, regions, or other defined physical positions that a user 301 in possession of the location authentication token 310 would be. The pre-registration may be accomplished through use of an appropriate web site, or by default defined by a location, or course location, of the authentication token 310 at a time of authorized pre-registration by the authorized and rightful user.

Upon detection of a match between a location-aided PIN of a user 301, matching a pre-registered value of the PIN and authorized locations for use of the location authentication token 310, then the person 301 attempting access can be determined to be properly authorized for access.

The invention also provides a network based location security embodiment where a current location of the location authentication token 310 is obtained from a suitable network (e.g., a Position Determining Entity (PDE) or the like). Such technique may be appropriate if the location authentication token 310 does not have access to a GPS chip within the location authentication token 310. Such technique may also be best to prevent spoofing of the wireless network where an ill-intended user of the location authentication token 310 hacks into the location authentication token 310 and causes it to provide a false self-obtained current location to the wireless network resource being accessed.

In such embodiment, the location authentication token 310 communicates over a suitable out-of-band channel such as SMS, USSD, HTTP, and/or HTTPS to send a mobile-originated location request to a location server.

In response, the appropriate network location server responds back with a network-determined current location of the location authentication token 310. This independently-obtained current location information is then used as a third, location based level of security, along with the otherwise conventional security provided by a passphrase/key, to construct a key used by the person 301 trying to access the secure system.

The accessed secure system, e.g., the authentication key verifying server 320, validates the key in combination with the current location value independently obtained for the location authentication token 310, and compares it to the key and the provisioned location value. If they match, then the person 301 in physical possession of the location authentication token 310 is then authorized for access.

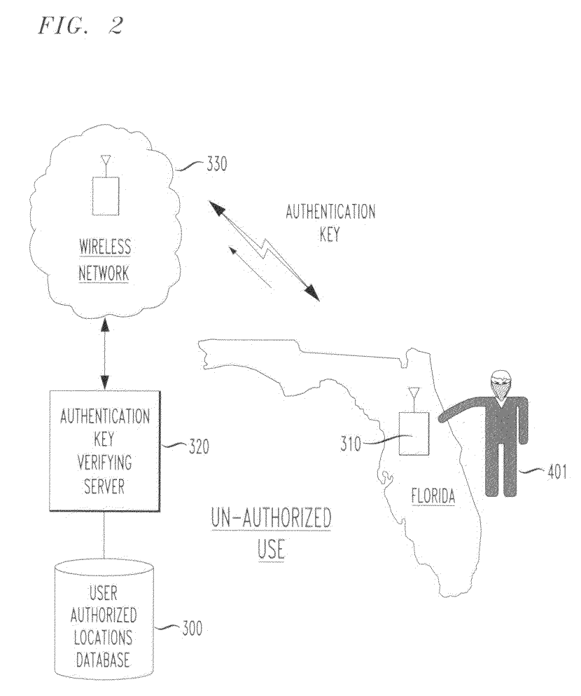

FIG. 2 depicts the refusal of the location authentication token 310 of FIG. 1, but this time in possession of an unauthorized user 401 (e.g., a thief who stole the authentication token from the authorized user), who attempts to access the relevant wireless network from a location other than the pre-registered location(s), in accordance with the principles of the present invention.

In particular, as shown in FIG. 2, the location authentication token 310 is stolen by a thief 401, and carried by them to a location, region, state, etc. that is not among those pre-registered or pre-authorized for use of the location authentication token 310. The thief 401 attempts to access the secure wireless network resource, but is rebuked by the authentication key verifying server 320 which determines, through comparison of a current location of the location authentication token 310 to pre-registered or otherwise pre-authorized location(s) for authorized use of the location authentication token 310 maintained in a suitable database, e.g., user authorized locations database 300.

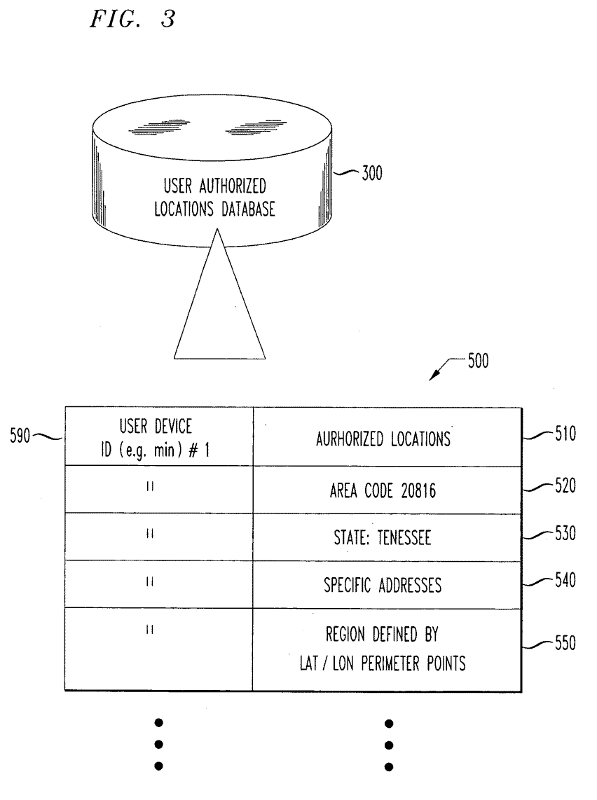

FIG. 3 depicts details of an exemplary user authorized locations database, in accordance with the principles of the present invention.

In particular, as shown in FIG. 3, the user authorized locations database 300 includes pre-registered entries 500 for each authorized user. An exemplary user entry for authorized locations includes an association of a unique ID 590 for the relevant location authentication token 310, and one or more authorized locations, regions, etc. for authorized use of that location authentication token 310. If the authentication key verifying server 320 finds no entry 510-550 including the current location of the location authentication token 310 of where it is as it attempts access to the secure network resource (e.g., as used by the thief 401 of FIG. 2), then authorization for access is denied.

Access denial may be reported to an appropriate network manager, or local law enforcement authority, together with a time, date and location of the denial, to assist in recovery of a stolen location authorization token 301.

The present invention is applicable to personal data assistants (PDAs), laptops and mobile devices as standalone security. While conventional security tokens are used to restrict access to data on websites, the present invention may be applied to secure access to data or applications running on devices such as personal data access (PDA) devices.

For devices containing sensitive information, the user can provision the location where device can be used. If device is stolen, device becomes useless unless operated within the provisioned location.

The invention also has applicability to a company interested in enforcing strict data access policies by requiring use of a security token.

The invention may be embodied in a software based solution running on a GPS capable device, a mobile or other wireless device, or a PDA. Military applications may utilize the invention by implementing enforcement of data access restrictions based on location.

While the invention has been described with reference to the exemplary embodiments thereof, those skilled in the art will be able to make various modifications to the described embodiments of the invention without departing from the true spirit and scope of the invention.

What is claimed is:

1. An authentication token having at least three levels of security, comprising:
an authorization request module to trigger a wireless authorization request to a network being accessed, including a current location of an associated physical authentication token; and
a passcode entry module to accept entry of a passcode authorizing access to said network being accessed;
wherein authorization of access to said network being accessed is contingent upon both said current location being in an authorized location for said physical authentication token, and said passcode being an authorized passcode.

2. The authentication token having at least three levels of security according to claim 1, wherein:
said authorized location is maintained in a user authorized locations database accessible by said network being accessed.

3. The authentication token having at least three levels of security according to claim 2, wherein:
said authorized passcode is maintained in said user authorized locations database accessible by said network being accessed.

4. The authentication token having at least three levels of security according to claim 1, wherein:
said authorized passcode is maintained in a user authorized locations database accessible by said network being accessed.

5. A method of providing a third level of security to an authentication token fob, comprising:
obtaining a current location of an authentication token fob associated with an attempt to access a relevant secure network resource;
combining said obtained current location with a passcode entered by a current user associated with said authentication token fob to form a passcode key; and
comparing said passcode key to a database of authorized passcode keys associated with said authentication token fob, to determine authorization for access to said relevant secure network resource;
wherein physical possession of said authentication token fob and entry of an authorized passcode are combined with a determination of an authorized location for use of said authentication token fob to provide three levels of security for access to said relevant secure network resource.

6. The method of providing a third level of security to an authentication token fob according to claim 5, wherein:
said current location is obtained from a satellite chip on said authentication token fob itself.

7. The method of providing a third level of security to an authentication token fob according to claim 5, wherein:
said current location is obtained from a physical wireless network location server.

8. The method of providing a third level of security to an authentication token fob according to claim 7, wherein:
said physical wireless network location server is a position determining entity (PDE).

9. A method of providing a location-based level of security to an authentication token, comprising:
obtaining a current location of an authentication token associated with an attempt to access a relevant secure network resource; and
comparing said current location of said authentication token to a database of authorized locations for use of said authentication token, to determine authorization for access to said relevant secure network resource;
wherein access to said relevant secure network resource is gained only when said authentication token is in an authorized region for authorized use.

10. The method of providing a location-based level of security to an authentication token according to claim 9, wherein:
said authorized region is a coarse GPS location.

11. The method of providing a location-based level of security to an authentication token according to claim 9, wherein:
said current location is obtained from a satellite chip on said authentication token itself.

12. The method of providing a location-based level of security to an authentication token according to claim 9, wherein:
said current location is obtained from a physical wireless network location server.

13. The method of providing a location-based level of security to an authentication token according to claim 12, wherein:
said physical wireless network location server is a position determining entity (PDE).
